(19) United States
(12) Patent Application Publication
(10) Pub. No.: US 2013/0239955 A1
(43) Pub. Date: Sep. 19, 2013

(54) METHOD FOR THE ACID-CATALYZED DEPOLYMERIZATION OF CELLULOSE

(71) Applicants: Ferdi Schüth, Mulheim an der Ruhr (DE); Roberto Rinaldi, Mulheim an der Ruhr (DE); Niklas Meine, Mulheim an der Ruhr (DE)

(72) Inventors: Ferdi Schüth, Mulheim an der Ruhr (DE); Roberto Rinaldi, Mulheim an der Ruhr (DE); Niklas Meine, Mulheim an der Ruhr (DE)

(21) Appl. No.: 13/989,439

(22) PCT Filed: Nov. 22, 2011
(86) PCT No.: PCT/DE11/75282

§ 371 Date: Jun. 11, 2013

(30) Foreign Application Priority Data
Nov. 25, 2010 (DE) 10 2010 052 602.9
Feb. 23, 2011 (DE) 10 2011 012 102.1

(51) Int. Cl. C13K 13/00

(52) U.S. Cl. CPC C13K 13/00
USPC 127/37

(57) ABSTRACT

A method for the acid-catalyzed depolymerization of cellulose comprises a mechanical treatment of cellulose in the presence of an inorganic and/or organic acid. The catalytic conversion of cellulose into water-soluble products is virtually completely achieved in that celluoligomers, cellubiose, glucose and glycerol are obtained without significant byproduction.

The present invention relates to a method for the acid-catalyzed depolymerization of cellulose wherein cellulose is brought into contact with an acid while being subjected to the agency of mechanical energy.

The use of biomass as a base material for fuelstocks and for chemical foundationstocks is currently a major research interest. Cellulose, the main component of lignocellulosic biomass, is viewed as a possible raw material. To obtain suitable and workable products, the cellulose has to be broken down into smaller molecules.

Mechanical grinding was tried at the start of the 20th century as a method of converting cellulose into smaller molecules. Ball mills were used to reduce the crystallinity of the cellulose. Grohn et al. (Journal of Polymer Science 1958, 30, 551) developed a method for converting cellulose into water-soluble products at a conversion rate of 90%, by grinding the cellulose in a steel tank for 900 hours.

A further attempt, the catalytic hydrolysis of cellulose, is disclosed in WO 2009/061750, which discloses a method for the production of soluble sugars from a cellulose-containing material. The cellulose-containing material is contacted with a solid acid and stirred therewith for a prolonged period in order that a product comprising soluble sugars may be obtained. However, the solid acid used has the disadvantage that it is virtually consumed during the process, so the catalytic activity decreases in the course of the process and catalyst recovery is also incomplete. The conversion of the cellulose-containing materials into water-soluble substances is incomplete.

The present invention had for its object to further improve the methods for the acid-catalyzed depolymerization of cellulose and obtain a very complete conversion of cellulose into water-soluble products.

The present invention accordingly provides a method for the acid-catalyzed depolymerization of cellulose wherein cellulose is subjected to a mechanical treatment in the presence of an acid, such as an inorganic and/or organic acid.

Surprisingly, the catalytic conversion of cellulose into water-soluble products is virtually completely achieved when the cellulose, or to be more precise the cellulose-containing material, is subjected to a mechanical treatment in the presence of a strong inorganic and/or organic acid. Celluoligomers, cellobiose, glucose and glycerol are obtained without significant byproduction. The cellulose, or to be more precise the cellulose-containing material, is not restricted to previously cleaned/purified celluloses or particular celluloses in that yields for conversion into water-soluble products for even untreated natural products are 75% and 87% for hay and sprucewood respectively and even above 99% for beechwood or sugarcane bagasse.

Cellulose herein is to be understood as meaning pure cellulose or cellulose-containing materials. Not only natural products, such as wood and grasses, but also chemically pure celluloses and cellulose-containing materials can be used.

The method of the present invention is carried out using an inorganic and/or organic acid. Particularly good conversion results are obtained when the inorganic acid has a pKa value <3, preferably the pKa value is between −14 and 2. Suitable examples of inorganic acids are mineral acids such as sulfuric acid, hydrochloric acid, phosphoric acid, phosphotungstic acid, halo-alkanecarboxylic acid, such as trifluoroacetic acid and nitric acid, although nitric acid is less preferable.

Particularly good conversion results are obtained when the organic acid has a pKa value <3, preferably the pKa value is between −14 and 2. Suitable examples of organic acids are benzenesulfonic acids and derivatives thereof, methanesulfonic acid, trifluoroacetic acid and oxalic acid.

Mixtures of the aforementioned acids can also be used. Preference is given to acids having a pKa value below −2.

The inorganic and/or organic acid is used in catalytic amounts in the method of the present invention. Preferably, the inorganic and/or organic acid is in an amount of 0.0001 to 6.2 mmol per g of cellulose.

In an advantageous embodiment of the method according to the present invention, the inorganic and/or organic acid is not brought into contact with the cellulose directly, and instead the cellulose-containing material is impregnated with a solution of the inorganic and/or organic acid in a suitable solvent in a first process step. This procedure will be found advantageous for inorganic acids in particular. To carry it out, the acid is preferably first mixed with a suitable solvent. A suitable solvent is any solvent that does not have an adverse effect on the reaction, such as water and organic solvents such as diethyl ether, dichloromethane, ethanol, methanol, THF, acetone and any other polar or apolar solvent in which the acid used is soluble, or which enables good mixing of cellulose and acid in a dispersion and which has a boiling point of 100° C. or therebelow. In this possible process step, the solution/dispersion of the inorganic and/or organic acid is mixed with the cellulose-containing material with or without being subsequently allowed to stand for some time. The solvent can be removed again before the mechanical treatment of the cellulose. Notably a low-boiling solvent is simple to remove again, either by slight heating and/or by applying a vacuum. The acid, which typically has a higher boiling point, remains behind on the cellulose material. This can be followed by the mechanical treatment of the cellulose in the presence of the inorganic and/or organic acid. It was determined that the degree of conversion of the cellulose can be increased by impregnating the cellulose material with inorganic and/or organic acid in the presence of a solvent.

It is also possible for the mixture of cellulose with solvent and acid to be submitted to mechanical treatment, although this form of processing is less preferable.

The mechanical treatment can be effected by grinding, extruding or kneading for example. The mills which can be used use grinding media to comminute the millbase, examples being swing mills, stirred mills, stirred-media mills, ball mills, etc. Ball mills are particularly preferred. Any extruder known from the prior art can be used.

As already reported at the outset, virtually qualitative conversions of cellulose materials can be achieved with the method of the present invention. Water-soluble celluoligomers, cellubiose, glucose and glycerol are obtained, while the formation of byproducts can be substantially avoided.

When the method of the present invention is carried out in a ball mill, speeds of 400 to 1200 and preferably of 800 to 1000 rpm will prove suitable. The reaction time, i.e., the time for which the mechanical treatment is applied, is typically in the range from 0.01 to 24 hours, although periods of 1.5 to 12 hours are sufficient.

Examples are provided hereinbelow by way of further elucidation, not limitation of the present invention.

### EXAMPLES

### Example 1

0.52 mL of sulfuric acid (95-97%, commercial product from J. T. Baker, USA) was dissolved in 150 mL of diethyl ether. 10 g of a-cellulose were then added and the suspension was shaken with a shaker (IKA, KS 130 control) at a frequency of 350 l/min for 1 hour. Thereafter the solvent was removed. 1.00 g of the dry mixture was ground in a steel beaker with steel balls (5 steel balls; individual weight 3.95 g) in a Pulverisette P7 from Fritsch. The speed of the main disk was 800 rpm. A sample of the solid material obtained was derivatized with phenyl isocyanate for GPC analysis. A further sample was dissolved in water and analyzed using HPLC.

The acid-catalyzed depolymerization of cellulose by ball-milling for 2 hours resulted in complete conversion of the cellulose into water-soluble products having a degree of polymerization of 3 anhydroglucose units (AGUs). The products are 94% water-soluble cello-oligomers, 3% glycerol, 1% cellobiose and 2% glucose.

### Example 2

0.52 mL of sulfuric acid (95-97%, commercial product from J. T. Baker, USA) was dissolved in 150 mL of diethyl ether. 10 g of a-cellulose were then added and the suspension was shaken with a shaker (IKA, KS 130 control) at a frequency of 350 l/min for 1 hour. Thereafter the solvent was removed. 1.00 g of the dry mixture was ground in a steel beaker with steel balls (5 steel balls; individual weight 3.95 g) in a Pulverisette P7 from Fritsch. The speed of the main disk was 800 rpm. A sample of the solid material obtained was derivatized with phenyl isocyanate for GPC analysis. A further sample was dissolved in water and analyzed using HPLC.

The acid-catalyzed depolymerization of cellulose by ball-milling for 30 minutes resulted in a conversion of the cellulose into 59% of water-soluble products having a degree of polymerization of 31 anhydroglucose units (AGUs).

To determine the solubility in water, 0.5 g of the products from grinding was shaken with water in a centrifuge tube and centrifuged. The residue was twice washed and centrifuged, then dried at 90° C. overnight and weighed. Water solubility was found to be 59% from this value. The water-soluble products were also analyzed using HPLC.

### Example 3

0.76 mL of sulfuric acid (85%, commercial product from Fluka, USA) was dissolved in 150 mL of diethyl ether. 10 g of a-cellulose were then added and the suspension was shaken with a shaker (IKA, KS 130 control) at a frequency of 350 l/min for 1 hour. Thereafter the solvent was removed. 1.00 g of the dry mixture was ground in a steel beaker with steel balls (5 steel balls; individual weight 3.95 g) in a Pulverisette P7 from Fritsch. The speed of the main disk was 800 rpm. A sample was dissolved in water and analyzed using HPLC.

The acid-catalyzed depolymerization of cellulose by ball-milling for 2 hours resulted in complete conversion of the cellulose into water-soluble products.

### Example 4

0.58 mL of orthophosphoric acid (85%, commercial product from Fluka, USA) was dissolved in 150 mL of diethyl ether. 10 g of a-cellulose were then added and the suspension was shaken with a shaker (IKA, KS 130 control) at a frequency of 350 l/min for 1 hour. Thereafter the solvent was removed. 1.00 g of the dry mixture was ground in a steel beaker with steel balls (5 steel balls; individual weight 3.95 g) in a Pulverisette P7 from Fritsch. The speed of the main disk was 800 rpm. A sample was dissolved in water and analyzed using HPLC.

The acid-catalyzed depolymerization of cellulose by ball-milling for 5 hours resulted in a conversion of the cellulose into 36% of water-soluble products.

To determine the solubility in water, 0.5 g of the products from grinding was shaken with water in a centrifuge tube and centrifuged. The residue was repeatedly washed and centrifuged, then dried at 90° C. overnight and weighed. Water solubility was found to be 36% from this value. The water-soluble products were also analyzed using HPLC.

### Example 5

0.52 mL of sulfuric acid (95-97%, commercial product from J. T. Baker, USA) was dissolved in 150 mL of diethyl ether. 10 g of comminuted sugarcane bagasse were then added and the suspension was shaken with a shaker (IKA, KS 130 control) at a frequency of 350 l/min for 1 hour. Thereafter the solvent was removed. 1.00 g of the dry mixture was ground in a steel beaker with steel balls (5 steel balls; individual weight 3.95 g) in a Pulverisette P7 from Fritsch. The speed of the main disk was 800 rpm. The water-soluble products were analyzed using HPLC.

The acid-catalyzed depolymerization of sugarcane bagasse by ball-milling for 2 hours resulted in almost complete conversion (99.9%) of the sugarcane bagasse into water-soluble products.

### Example 6

0.52 mL of sulfuric acid (95-97%, commercial product from J. T. Baker, USA) was dissolved in 150 mL of diethyl ether. 10 g of sawn beechwood shavings were then added and the suspension was shaken with a shaker

(IKA, KS 130 control) at a frequency of 350 l/min for 1 hour. Thereafter the solvent was removed. 1.00 g of the dry mixture was ground in a steel beaker with steel balls (5 steel balls; individual weight 3.95 g) in a Pulverisette P7 from Fritsch. The speed of the main disk was 800 rpm. The water-soluble products were analyzed using HPLC.

The acid-catalyzed depolymerization of beechwood by ball-milling for 2 hours resulted in a conversion of the sawn beechwood shavings into water-soluble products.

### Example 7

0.52 mL of sulfuric acid (95-97%, commercial product from J. T. Baker, USA) was dissolved in 150 mL of diethyl ether. 10 g of sawn pinewood shavings were then added and the suspension was shaken with a shaker (IKA, KS 130 control) at a frequency of 350 l/min for 1 hour. Thereafter the solvent was removed. 1.00 g of the dry mixture was ground in a steel beaker with steel balls (5 steel balls; individual weight 3.95 g) in a Pulverisette P7 from Fritsch. The speed of the main disk was 800 rpm. The water-soluble products were analyzed using HPLC.

The acid-catalyzed depolymerization of pinewood by ball-milling for 2 hours resulted in a conversion of the sawn pinewood shavings into 87% of water-soluble products.

### Example 8

0.52 mL of sulfuric acid (95-97%, commercial product from J. T. Baker, USA) was dissolved in 150 mL of diethyl ether. 10 g of hay were then added and the suspension was shaken with a shaker (IKA, KS 130 control) at a frequency of 350 l/min for 1 hour. Thereafter the solvent was removed. 1.00 g of the dry mixture was ground in a steel beaker with steel balls (5 steel balls; individual weight 3.95 g) in a Pulverisette P7 from Fritsch. The speed of the main disk was 800 rpm. The water-soluble products were analyzed using HPLC.

The acid-catalyzed depolymerization of hay by ball-milling for 2 hours resulted in a conversion of the hay into 75% of water-soluble products.

TABLE 1
Depolymerization of α-cellulose (1.00 g) with
inorganic acids (0.92 mmol) in a planetary mill.
Grinding was preceded by dissolving the acid in diethyl
ether, dispersing the cellulose and removing the
solvent.

| | Grind time at | Water-soluble |
|---|---|---|
| Experiment | 800 rpm [h] | products [%] |
| Cellulose impregnated with H₂SO₄ | 0 | 18 |
| (without mechanical treatment) | | |
| Cellulose + H₂SO₄ | 0.25 | 38 |
| Cellulose + H₂SO₄ | 0.5 | 59 |
| Cellulose + H₂SO₄ | 1 | 84 |
| Cellulose + H₂SO₄ | 1.5 | 97 |
| Cellulose + H₂SO₄ | 2 | 100 |
| Cellulose impregnated with HCl | 0 | 11 |
| (without mechanical treatment) | | |
| Cellulose + HCl | 1 | 77 |
| Cellulose + HCl | 2 | 100 |
| Cellulose + H₃PO₄ | 5 | 38 |

TABLE 2
Depolymerization of α-cellulose (1 g,
6.2 mmol based on AGU units) with
sulfuric acid in a planetary mill

| Grind time at | | n_{catalyst} | | |
|---|---|---|---|---|
| 800 rpm (h) | Catalyst | (mmol) | DPw | DPn |
| 0.5 | H₂SO₄ | 0.92 | 31 | 19 |
| 2 | H₂SO₄ | 0.92 | 3 | 3 |

TABLE 3
Depolymerization of lignocellulosic biomass
(1.00 g) with sulfuric acid (0.92 mmol) in a planetary
mill. Grinding was preceded by dissolving the acid in
diethyl ether, dispersing the lignocellulosic biomass
and removing the solvent.

| | Grind time at | Water-soluble |
|---|---|---|
| Biomass | 800 rpm [h] | products [%] |
| Sugarcane bagasse | 2 | 99.9 |
| Beechwood | 2 | 99.9 |
| Pinewood | 2 | 87 |
| Hay | 2 | 75 |

1. A method for the acid-catalyzed depolymerization of cellulose, said method comprising mechanically treating cellulose-containing material in the presence of an inorganic and/or organic acid in a catalytic amount, wherein the mechanically treating the cellulose with an acid is preceded by treating the cellulose with a mixture of said acid in a solvent and removing the solvent before the mechanically treating whereby the mechanically treating comprises grinding wherein the millbase is comminuted using grinding media.

2. The method as claimed in claim 1, wherein the acid has a pKa value of −14 to 2.

3. The method as claimed in claim 1, wherein the inorganic acid is selected from sulfuric acid, hydrochloric acid, phosphoric acid, nitric acid, haloalkanecarboxylic acids, phosphotungstic acid and mixtures thereof

4. The method as claimed in claim 1, wherein the organic acid is selected from benzenesulfonic acid, p-toluenesulfonic acid, nitrobenzenesulfonic acids, 2,4,6-trimethylbenzenesulfonic acid, or derivatives thereof, methanesulfonic acid, maleic acid, oxalic acid, haloalkanecarboxylic acids and mixtures thereof.

5. The method as claimed in claim 1, wherein the inorganic acid is used in an amount of 0.0001 to 6.2 mmol per g of cellulose-containing material.

6-8. (canceled)

9. The method as claimed in claim 5, wherein a mill is used, and the mill is selected from swing mills, stirred mills, stirred-media mills and ball mills.

10. (canceled)

11. The method as claimed in claim 1, which yields water-soluble celluoligomers, cellobiose, glucose and/or glycerol as reaction products.
